(19) United States
(12) Patent Application Publication
(10) Pub. No.: US 2004/0197663 A1
(43) Pub. Date: Oct. 7, 2004

(54) Polymer electrolyte membrane for fuel cells

(76) Inventors: Helmut Mohwald, Annweiler (DE); Andreas Fischer, Ludwigshafen (DE); Jean-Claude Heilig, Frakenthal (DE); Ingolf Hennig, Neulussheim (DE)

Correspondence Address: KEIL & WEINKAUF, 1350 CONNECTICUT AVENUE, N.W., WASHINGTON, DC, 20036, US

(21) Appl. No.: 10/482,226

(22) PCT Filed: Jul. 2, 2002
(86) PCT No.: PCT/EP02/07300

(30) Foreign Application Priority Data
Jul. 2, 2001 (DE) 101 31 919.3

(51) Int. Cl. H01M 10/40; H01M 8/10

(52) U.S. Cl. 429/309; 429/306; 429/30

(57) ABSTRACT

A polymer electrolyte composition comprising from 20 to 99% by weight, based on the composition, of at least one non-functionalized polymer as matrix and from 80 to 1% by weight, based on the composition, of at least one inorganic or organic low-molecular-weight solid or at least one inorganic or organic polymeric solid, each of which is capable of taking up and releasing protons, or a mixture thereof.

The present invention relates to a polymer composition comprising a non-functionalized polymer and inorganic, organic or polymeric solids which are capable of taking up and releasing protons, and to the use of this composition as polymer electrolyte membrane and in fuel cells or in other electrochemical systems.

The present invention is in the technical area of fuel cells. Fuel cell technology is regarded as one of the core technologies of the 21st century, both for stationary applications, for example power stations and block-type thermal power stations, mobile applications, for example in automobiles, trucks, buses, etc., in portable applications, for example in cellphones and laptops, and in so-called auxiliary power units (APU), such as the power supply in motor vehicles. The reason for this is that the efficiency on use and in energy conversion starting from the respective fuel is greater in the fuel cell than in conventional internal-combustion engines. In addition, the fuel cell has significantly lower harmful emissions. The basic reaction of the polymer electrolyte membrane (PEM) fuel cell consists in the anodic conversion of the fuel H₂ (hydrogen) into protons, which then migrate through the proton-conductive membrane from the anode to the cathode, where they come into contact with oxygen anions in the cathode chamber, with water being formed as reaction product and in addition electricity and heat being produced.

One of the greatest challenges in the provision of functioning fuel cells is to develop inexpensive membranes which separate the cathode and anode chambers from one another and at the same time are permeable to protons, but impermeable to other constituents present in the system, for example hydrogen, i.e. the membrane must, inter alia, be gastight. An overview of the current state of the art in the area of fuel cells is given in J. A. Kerres in “Journal of Membrane Science”, 185 (2001, pp. 3-27), in a further review article by G. Marsh in “Materials Today” Vol. 4, No. 2 (2001), pp. 20-24, and in WO 00/35037, a patent application concerned, in particular, with anode structures which are suitable for fuel cells. As is evident from the state of the art, the materials currently employed for the polymer electrolyte membrane (PEM) in industrially manufactured low-temperature fuel cells (up to 100° C.) are primarily perfluorinated and sulfonated polymers, for example Nafion® or Flemion®. Other polymer systems, for example polyether ether ketones, polyimides and polystyrenes, are likewise functionalized, i.e. provided with functional groups which are able to take up and release protons, for example —SO₃H or —CO₂H, in order to achieve adequate proton conductivity.

The polymer systems used hitherto are, in particular, disadvantageous in that either they are only commercially available at high prices and/or have to be produced with considerable effort, in some cases using toxic starting materials. Furthermore, the majority of the systems used hitherto cannot be recycled.

In consideration of this state of the art, it is an object of the present invention to provide a polymer electrolyte composition or membranes and composite elements containing these which are suitable for fuel cells and which can be produced more simply and/or inexpensively than the polymer systems used hitherto.

We have found that this object is achieved by a polymer electrolyte composition comprising from 20 to 99% by weight, based on the composition, of at least one non-functionalized polymer as matrix and from 80 to 1% by weight, based on the composition, of at least one inorganic or organic low-molecular-weight solid or at least one inorganic or organic polymeric solid which is capable of taking up and releasing protons, or of a mixture thereof.

For the purposes of the present invention, the term “non-functionalized” means that the polymers used in the present invention are neither perfluorinated or sulfonated (ionomeric) polymers, for example Nafion® or Flemion®, nor polymers which have been functionalized with suitable groups, for example —SO₃H or —CO₂H, in order to achieve adequate proton conductivity, as are used in the state of the art. The reason for this is that, in the polymer electrolyte composition in accordance with the present invention, the proton conductivity results from the presence of the organic and/or inorganic low-molecular-weight solids and/or organic and/or inorganic polymeric solids, each of which is capable of taking up and releasing protons.

The term “low-molecular-weight” used here in accordance with the invention means that these are solids whose molecular weight does not exceed 500.

There are absolutely no particular restrictions regarding the non-functionalized polymers which can be used in the present invention, so long as these polymers are stable under the conditions prevailing in a fuel cell. Preference is accordingly given to polymers which are thermally stable up to 100° C., further preferably up to 200° C. or above, and have the highest possible chemical stability.

The following polymers are preferably employed:

polymers having an aromatic backbone, for example polyimides, polysulfones and polybenzimidazoles; polymers having a fluorinated backbone, for example Teflon and PVDF; olefinic, preferably fluorinated, polymers and copolymers; thermo-plastic polymers and copolymers, for example polycarbonates and polyurethanes, as described, for example, in WO 98/44576; crosslinked polyvinyl alcohols; vinyl polymers.

Vinyl polymers which may be mentioned in particular are the following:

polymers and copolymers of styrene or methylstyrene, vinyl chloride, acrylonitrile, methacrylonitrile, N-methylpyrrolidone, N-vinylimidazole or vinyl acetate; vinylidene fluoride; copolymers of vinyl chloride and vinylidene chloride, vinyl chloride and acrylonitrile, vinylidene fluoride and hexafluoropropylene, and vinylidene fluoride with hexafluoropropylene; terpolymers of vinylidene fluoride and hexafluoropropylene and a member from the group consisting of vinyl fluoride, tetrafluoroethylene and trifluoroethylene. Polymers of this type are described, for example, in U.S. Pat. No. 5,540,741 and U.S. Pat. No. 5,478,668, whose entire disclosure content in this respect is incorporated into the context of the present application by way of reference. Of these, preference is in turn given to copolymers of vinylidene fluoride (1,1-difluoroethene) and hexafluoropropene, furthermore preferably random copolymers of vinylidene chloride and hexafluoropropene, in which the proportion by weight of the vinylidene fluoride is from 75 to 92% and that of the hexafluoropropene is from 8 to 25%.

The following can also be employed:

phenol-formaldehyde resins, polytrifluorostyrene, poly-2,6-diphenyl-1,4-phenylene oxide, polyaryl ether sulfones, polyarylene ether sulfones, polyaryl ether ketones and phosphonated poly-2,6-dimethyl-1,4-phenylene oxide.

Polycarbonates, for example polyethylene carbonate, polypropylene carbonate, polybutadiene carbonate and polyvinylidene carbonate.

Homopolymers, block polymers and copolymers prepared from

a) olefinic hydrocarbons, for example ethylene, propylene, butylene, isobutene, propene, hexene or higher homologs, butadiene, cyclopentene, cyclohexene, norbornene and vinylcyclohexane;

b) esters of acrylic or methacrylic acid, such as methyl, ethyl, propyl, isopropyl, butyl, isobutyl, hexyl, octyl, decyl, dodecyl, 2-ethylhexyl, cyclohexyl, benzyl, trifluoromethyl, hexafluoropropyl and tetrafluoropropyl acrylate or methacrylate;

c) vinyl ethers, for example methyl, ethyl, propyl, isopropyl, butyl, isobutyl, hexyl, octyl, decyl, dodecyl, 2-ethylhexyl, cyclohexyl, benzyl, trifluoromethyl, hexafluoropropyl and tetrafluoropropyl vinyl ether.

Polyurethanes, obtainable, for example, by reaction of

a) organic diisocyanates having from 6 to 30 carbon atoms, for example aliphatic acyclic diisocyanates, for example 1,5-hexamethylene diisocyanate and 1,6-hexamethylene diisocyanate, aliphatic cyclic diisocyanates, for example 1,4-cyclohexylene diisocyanate, dicyclohexylmethane diisocyanate and isophorone diisocyanate, or aromatic diisocyanates, for example tolylene 2,4-diisocyanate, tolylene 2,6-diisocyanate, m-tetramethylxylene diisocyanate, p-tetramethylxylene diisocyanate, 1,5-tetrahydronaphthylene diisocyanate and 4,4′-diphenylmethane diisocyanate, or mixtures of such compounds, with

b) polyhydric alcohols, for example polyesterols, polyetherols and diols, as described, for example, in WO 98/44576.

The polymers, in particular the abovementioned polymers, can be employed in crosslinked or uncrosslinked form.

There are absolutely no restrictions regarding the compounds employed as solids so long as they are able to take up and release protons and are stable at the operating temperatures of the fuel cell, i.e. the solids should be stable at 80° C. or above, preferably 150° C. or above and in particular at temperatures of 200° C. or above.

It is thus possible to employ all inorganic or organic low-molecular-weight solids or inorganic or organic polymeric solids which are capable of taking up and releasing protons.

The following may be mentioned in detail:

phyllosilicates, for example bentonite, montmorillonite, serpentine, kalinite, talc, pyrophyllite and mica, reference being made regarding further details to Hollemann-Wiberg, Lehrbuch der Anorganischen Chemie [Textbook of Inorganic Chemistry], 91st to 100th Edition (1985), pp. 771 ff.

Aluminosilicates, for example zeolites.

Non-water-soluble organic carboxylic acids, for example those having from 5 to 30 carbon atoms, preferably having from 8 to 22 carbon atoms, particularly preferably having from 12 to 18 carbon atoms, containing a linear or branched-chain alkyl radical, which, if desired, have one or more further functional groups; functional groups which may be mentioned are, in particular, hydroxyl groups, C—C double bonds or carbonyl groups. In detail, the following carboxylic acids may be mentioned by way of example: valeric acid, isovaleric acid, 2-methylbutyric acid, pivalic acid, caproic acid, oenanthic acid, caprylic acid, pelargonic acid, capric acid, undecanoic acid, lauric acid, tridecanoic acid, myristic acid, pentadecanoic acid, palmitic acid, margaric acid, stearic acid, nonadecanoic acid, arachic acid, behenic acid, lignoceric acid, cerotinic acid, melissic acid, tubercolostearic acid, palmitoleic acid, oleic acid, erucic acid, sorbic acid, linoleic acid, linolenic acid, elaeostearic acid, arachidonic acid, culpanodonic acid and docosahexaenoic acid. Mixtures of two or more carboxylic acids can also be employed in accordance with the invention.

Polyphosphoric acids, as described, for example, in Hollemann-Wiberg, in loco citato, pp. 659 ff.

Mixtures of two or more of the abovementioned solids.

Preference is given to the use of phyllosilicates, which may also be employed in delaminated form.

There are absolutely no restrictions regarding the zeolites which can be employed as solids so long as they meet the conditions mentioned at the outset. As is known, zeolites are crystalline aluminosilicates having ordered channel and cage structures which have micropores. The term “micropores” as used in the present invention corresponds to the definition in “Pure Appl. Chem.” 45, pp. 71 ff, in particular p. 79 (1976), and denotes pores having a pore diameter of less than 2 nm. The network of zeolites of this type is built up from SiO₄ and AlO₄ tetrahedra, which are linked via common oxygen bridges. A review of the known structures is given, for example, in W. M. Meier and D. H. Olson in “Atlas of Zeolite Structure Types”, Elsevier, 4th Edition, London 1996.

Particularly suitable solids are those which have a primary particle size of from 1 nm to 20 μm, preferably from 1 nm to 1 μm and in particular from 10 nm to 500 nm, the stated particle sizes being determined by electron microscopy.

Preference is given here to solids which have a height:width:length size ratio (aspect ratio) of other than 1 and are in the form of needles, asymmetrical tetrahedra, asymmetrical bipyramids, asymmetrical hexahedra or octahedra, platelets, disks or fiber-shaped structures. If the solids are in the form of asymmetrical particles, the abovementioned upper limit for the primary particle size relates to the smallest axis in each case.

The composition comprises in accordance with the invention from 1 to 80% by weight, preferably from 1 to 40% by weight and in particular from 2 to 30% by weight, of solid and from 20 to 99% by weight, preferably from 60 to 99% by weight and in particular from 70 to 98% by weight of polymer, in each case based on the composition as a whole.

The polymers advantageously have an average molecular weight (number average) of from 5000 to 100,000,000, preferably from 50,000 to 8,000,000. They are polymerized by conventional methods which are well known to the person skilled in the art.

For the preparation of the composition according to the invention, the solid and the polymer, if desired together with a plasticizer, preferably a plasticizer as described in greater detail below, are mixed and, if desired, crosslinked.

The composition according to the invention may additionally comprise a plasticizer, typically in an amount of up to 10% by weight, preferably from 2 to 8% by weight, in each case based on the composition as a whole. Suitable plasticizers of this type are described in WO 99/19917 and WO 99/18625. Use is preferably made of NMP, propylene carbonate, ethylene carbonate, MEEK, aromatic solvent, tris(2-ethylhexyl)phosphate and protic systems, for example acid, alcohols and glycols.

The starting materials used for the respective composition may be dissolved or dispersed in an inorganic, preferably an organic, liquid diluent, where the resultant solution should have a viscosity of preferably from 100 to 50,000 mPas, and are subsequently, if desired, applied to a support material, i.e. shaped to give a film-shaped structure, in a manner known per se, such as casting, dipping, spin coating, roller coating, spray coating, printing by letterpress printing, gravure printing or planographic printing or screen printing methods, or alternatively by extrusion. The further processing can be carried out in the usual manner, for example by removal of the diluent and curing of the materials to completion.

After the membrane formation, volatile components, such as solvents or plasticizers, can be removed.

If crosslinking of the layers is desired, it can be carried out in a manner known per se, for example by irradiation with UV or visible light, ionic or ionizing radiation, electron beams, preferably with an acceleration voltage of from 20 to 2000 kV and a radiation dose of from 5 to 50 Mrad, it being advantageous to add, in the usual way, an initiator, such as benzil dimethyl ketal or 1,3,5-trimethylbenzoyl-triphenylphosphine oxide, in amounts of, in particular, at most 1% by weight, based on the crosslinking constituents in the starting materials, and the crosslinking can be carried out within in general from 0.5 to 15 minutes, advantageously under an inert gas, such as nitrogen or argon; by thermal free-radical polymerization, preferably at temperatures above 60° C., it being advantageous to add an initiator, such as azobisisobutyronitrile, in amounts of in general at least 5% by weight, preferably from 0.05 to 1% by weight, based on the crosslinking constituents in the starting materials.

Further crosslinking agents which can be used in the present invention are described in U.S. Pat. No. 5,558,911, the contents of which are incorporated into the context of the present application in their full scope.

The membranes produced in accordance with the invention generally have a thickness of from 5 to 500 μm, preferably to 10 to 500 μm, further preferably from 10 to 200 μm.

The present invention furthermore relates to a composite element comprising at least one first layer which comprises a composition according to the invention, and to a composite element of this type which furthermore comprises an electrically conductive catalyst layer. The composite element according to the invention may furthermore comprise one or more bipolar electrodes. The present invention furthermore relates to a composite element having the structure

[PEM-electrically conductive catalyst layer-bipolar electrode]ₙ

where n is preferably from 1 to 100, further preferably from 10 to 50.

The composite elements according to the invention furthermore have one or more gas distribution layers, for example a carbon nonwoven, between the bipolar electrode and the electrically conductive catalyst layer.

In addition, the present invention relates to the use of at least one composition according to the invention or of a composite element according to the invention as polymer electrolyte membrane in fuel cells and other electrochemical systems, and to an electrochemical system, preferably a fuel cell, containing a composition of this type or a composite element of this type.

For the purposes of the present invention, the typical structure of a fuel cell is regarded as known and reference is made in this respect to the prior art cited in the introductory part to the present application.

The polymer electrolyte composition according to the invention has essentially the following advantages over the polymer electrolyte compositions or membranes employed in the prior art:

the polymer used does not have to be prepared in a multistep synthesis in order to achieve adequate proton conductivity; this makes the preparation of the polymer significantly simpler and less expensive;

the mechanical, thermal and chemical properties of the polymer electrolyte composition can be varied virtually as desired through a variation in the components present as solids, i.e. the polymer and the solid;

the solid used increases the barrier action of the membrane to gases such as oxygen (O₂) and hydrogen (H₂);

the solid used increases the barrier action to liquids, for example methanol, and is therefore also suitable for the direct methanol fuel cell;

in contrast to the ceramic membranes used, in particular, in high-temperature fuel cells, the membranes produced using the polymer electrolyte composition according to the invention exhibit the typical, advantageous properties of a polymer film, i.e. they are, inter alia, thin, flexible and laminatable.

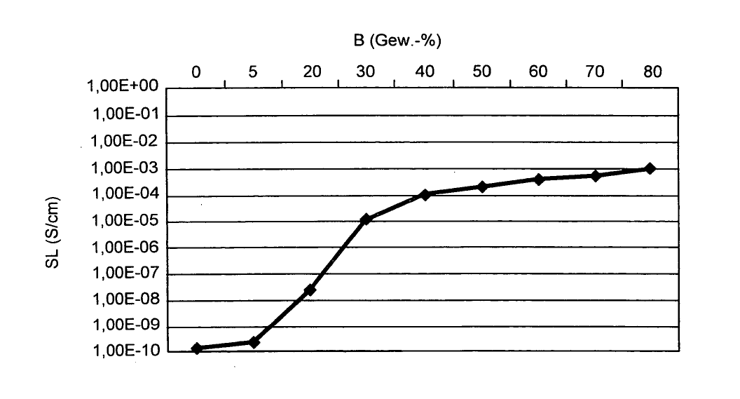

The present invention will now be explained in greater detail by means of the following examples with reference to FIG. 1.

FIG. 1 shows a plot of the specific conductivity (S/cm²) against the solids content within a polymer electrolyte membrane produced in accordance with Example 1.

### EXAMPLES

### Example 1

Firstly, 16.8 g of bentonite Cloisite®-Na from Southern Clay Products were dispersed in 96 g of methyl ethyl ketone. 7.2 g of a PVDF copolymer with the trade name Solef® 21216 from Solvay were subsequently added with further stirring, and the resultant mixture was heated to 80° C. and stirred. The resultant mixture was then applied to a support film of siliconized PET using a doctor blade in a wet layer thickness of 750 μm and dried at a temperature of 50° C. The resultant layer thickness of the membrane after drying was about 55 μm. The conductivity of the film activated with sulfuric acid was about 7.3×10⁻⁴ S/cm.

### Example 2

13.5 g of bentonite Cloisite®-Na in 127.5 g of N,N-dimethylacetamide were dispersed for 10 minutes with stirring. 9 g of Ultrason® S 6020 were subsequently added with stirring, and the resultant mixture was warmed to 80° C. This mixture was shaken for 2 hours at room temperature in a ball mill system. Films were then cast onto a support film at 60° C. using a doctor blade in a wet layer thickness of 650 μm. After drying at 60° C. for 15 minutes, a layer thickness of 138 μm was obtained. The conductivity of the film activated with sulfuric acid was approximately 8.70×10⁻³ S/cm².

### Example 3

A film was produced in accordance with the procedure of Example 1, but the bentonite content was varied between 0 and 80% by weight. The specific conductivity of the resultant film was subsequently measured. The results are shown in FIG. 1.

We claim:

1. A polymer electrolyte composition comprising
from 20 to 99% by weight, based on the composition, of at least one non-functionalized polymer as the matrix and
from 80 to 1% by weight, based on the composition, of at least one inorganic or organic low-molecular-weight solid or at least one inorganic or organic polymeric solid, each of which is capable of taking up and releasing protons, or a mixture thereof.

2. A polymer electrolyte composition as claimed in claim 1, where the non-functionalized polymer is selected from:
polyimides; polysulfones; polybenzimidazoles; Teflon; PVDF; olefinic polymers or copolymers, which may also be fluorinated; polycarbonates; polyurethanes; crosslinked polyvinyl alcohols; vinyl polymers; and mixtures of two or more thereof.

3. A polymer electrolyte composition as claimed in claim 1 or 2, where the inorganic, organic or polymeric solid is selected from:
phyllosilicates, zeolites, organic carboxylic acids, polyphosphoric acids, and mixtures of two or more thereof.

4. A polymer electrolyte composition as claimed in any one of the preceding claims, containing a plasticizer, wherein the plasticizer is selected from:
NMP, propylene carbonate, ethylene carbonate, MEEK, aromatic solvents, tris(2-ethylhexyl)phosphate and protic systems.

5. A polymer electrolyte composition as claimed in any one of the preceding claims, where, in each case based on the composition, the content of polymer is from 70 to 98% by weight and the content of solid is from 2 to 30% by weight.

6. A composite element comprising at least one first layer which comprises a composition as claimed in any one of the preceding claims.

7. A composite element as claimed in claim 6, furthermore comprising an electrically conductive catalyst layer.

8. A composite element as claimed in claim 7, having the following structure:
[Polymer Electrolyte Membrane PEM-electrically conductive catalyst layer-bipolar electrode]ₙ,
where n ranges from 1 to 100.

9. The use of at least one composition or of a composite element as claimed in any one of claims 1 to 8 as polymer electrolyte membrane in fuel cells and other electrochemical systems.

10. An electrochemical system, preferably a fuel cell, comprising a composition as claimed in any one of claims 1 to 6 or a composite element as claimed in claim 7 or 8.
